(19) United States
(12) Patent Application Publication
(10) Pub. No.: US 2009/0132769 A1
(43) Pub. Date: May 21, 2009

(54) STATISTICAL COUNTING FOR MEMORY HIERARCHY OPTIMIZATION

(75) Inventors: Steve Pronovost, Kenmore, WA (US); Ketan K. Dalal, Seattle, WA (US); Ameet A. Chitre, Duvall, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/942,259

(22) Filed: Nov. 19, 2007

(51) Int. Cl. G06F 12/02; G06F 12/08

(52) U.S. Cl. 711/145; 711/170; 711/E12.052; 711/E12.002

(57) ABSTRACT

Systems and methods that optimize memory allocation in hierarchical and/or distributed data storage. A memory management component facilitates a compact manner of identifying approximately how often the memory chunk is being used, to promote efficient operation of the system as a whole. Each memory location can be changed based on the corresponding memory access that is determined through tracking of statistical usage counts of memory locations, and a comparison thereof with a threshold value.

### BACKGROUND

Common computer-related problems involve managing large amounts of data or information. In general, information should be efficiently maintained to minimize the amount of storage required such that relevant data within the data set can be quickly located and retrieved.

Various systems and algorithms are employed in data processing machines to efficiently manage available memory resources. One such known algorithm is LRU (Least Recently Used), whereby the block in the buffer which was referenced least recently (e.g., longest not used) is assumed to be least important, and therefore can be written over, or replaced with minimum system performance impact. In general, LRU requires a method of keeping track of the relative usages of the contents in the respective blocks in the buffer.

For example, one conventional approach has been to keep the block addresses, or their representation, in a push-down stack, wherein the position in the stack denotes relative usage of the respective block contents. Push-down stacks have been designed with latching devices, and depending upon the size of the buffer and the size of the block, the stack can become quite large and expensive to implement.

Moreover, in such data processing system the speed of a processor (CPU) is typically much faster than its memory. Therefore, in order to allow a CPU to access data instantly and smoothly as possible, the storage of a CPU is often organized with a hierarchy of heterogeneous devices: multiple levels of caches, main memory, drums, random access buffered DASD (direct access storage devices) and regular DASDs. Logically, any memory access from the CPU has to search down the hierarchy until the data needed is found at one level, then the data must typically be loaded into all upper levels. Such arrangement and feeding of data to the CPU, on a demand basis, is the simplest and most basic way of implementing a memory hierarchy.

Furthermore, standard memory hierarchy designs generally assume that all accesses are to the fastest level of memory (e.g., L1 Cache) and that cache misses involve moving data to the L1 Cache. However, in complex systems, it can be possible for the memory operation to directly operate on lower levels of memory (e.g. L2 or L3) without contaminating the fast memory. Naturally, such bypass operation can accompany with some performance penalty. Accordingly, when faced with an access to memory that is not in the fastest memory, a choice exists wherein either: the memory can be moved to the fast memory (displacing something that is already there), or alternatively perform a slow, direct access to the slow memory.

Such complexities also arise in distributed systems that are not well described by a single hierarchy of fast/slow/slowest sets of memory. For example, in a multi-processor system, each processor may have an L1 cache, pairs may share L2 caches, and sets of four may share an L3 cache. Each writable block of memory can typically only be in one of these cache locations at any time (of a write operation). Optimizing such write operation indicates determining whether to move the block or perform a slow access directly to the block.

### SUMMARY

The following presents a simplified summary in order to provide a basic understanding of some aspects described herein. This summary is not an extensive overview of the claimed subject matter. It is intended to neither identify key or critical elements of the claimed subject matter nor delineate the scope thereof. Its sole purpose is to present some concepts in a simplified form as a prelude to the more detailed description that is presented later.

The subject innovation supplies an optimization system for memory placement in a hierarchical (and/or distributed) environment, by employing a memory management component that tracks statistical usage counts of memory locations, and a comparison thereof with a threshold value. Such optimization system employs an approximation of the count to keep track of how often a block or piece of memory is actually employed by the operating system (OS)—(as opposed to keeping track of complete usage count for such memory piece that can be expensive,—e.g., while performing 32-bit or 64-bit counter increments on every memory access the memory storage/bandwidth of 4-8 bytes per block can become prohibitive).

The hierarchical memory environment provides for data storage in a layered and multiple locations, wherein some locations supply faster access to data than other locations. Based on data usage during memory access and/or access to data locations, the memory management component facilitates a compact manner of identifying approximately how often the memory chunk is being used, to promote efficient operation of the system as a whole. Moreover, each memory location can be changed based on the corresponding memory access (e.g., data that is employed over and over can be placed in a relatively fast location, and data that is not substantially used can be placed in a location that is deemed relatively slow location). In a related aspect, the optimization system of the subject innovation exploits a predetermined number of bits (e.g., 1 bit or 2 bits as access bits) to track a memory page (e.g., a 4K page), wherein whenever a processing unit accesses the memory a random number can be generated that can be compared against a threshold value. If such random number exceeds the threshold value, the access bit can be set to “on” for the memory. Such access bit can remain “on”, until set to zero again (e.g., by the memory management component), to obtain additional data. The threshold value can be adaptively adjusted depending on number of times a memory location is accessed. Such threshold can be supplied by the memory management component, which also reads the access bits. Accordingly, whenever the processing unit accesses the memory blocks/chunks, a statistical test can be performed, which can change status of access bits (e.g., from off to on). The access bits (e.g., access threshold registers) are located within the processing unit, and based on their “on” status can provide feedback regarding allocation of memory and placement. A plurality of algorithms can be employed to track accesses to memory chunks. It is to be appreciated that such access bits have a very low probability of being set accidentally to “on” status—without substantial access as set by the threshold value.

As such, pages that are substantially used (as represented by the threshold value) can be distinguished from other pages (e.g., those that are not substantially used as represented by the threshold value.) Such threshold value can be set (e.g., randomly) by the memory management component, wherein based on results that are returned from the comparisons of numbers generated from access to memory by CPUs with a threshold number, access bits can be set to an “on” status. Subsequently decisions can be made as to where memory should be re-located. Hence, the threshold value can be adapted based on type of memory activity (e.g., raised if pages are used intensively.) It is to be appreciated that the subject innovation can also be applied to partitioned memory with heterogeneous performance characteristics.

In a related aspect, the optimization system further employs a heuristic counter(s) to track memory accesses via increments and/or resets thereto, wherein such counter is read and subsequently cleared from the optimization system of the subject innovation. Hence, activities of different processing units for access to memory locations can be monitored and compared to optimize memory placement.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 illustrates a block diagram of an optimization system that employs an approximation of the count to keep track of how often a block of memory is accessed.

FIG. 2 illustrates a further block diagram of an optimization system that includes a memory management component.

FIG. 3 illustrates a particular optimization system that exploits a predetermined number of bits to track a memory page.

FIG. 4 illustrates a related methodology of optimizing memory placement in accordance with an aspect of the subject innovation.

FIG. 5 illustrates a related methodology of statistical tracking for memory placement in accordance with an aspect of the subject innovation.

FIG. 6 illustrates an exemplary optimization system that employs counters according to an aspect of the subject innovation.

FIG. 7 illustrates a related methodology of moving memory locations in accordance with an aspect of the subject innovation.

FIG. 8 illustrates an artificial intelligence component that facilitates adjusting a threshold value according to an aspect of the subject innovation.

FIG. 9 illustrates an exemplary environment for implementing various aspects of the subject innovation.

FIG. 10 is a schematic block diagram of a sample-computing environment that can be employed for memory optimization according to an aspect of the subject innovation.

### DETAILED DESCRIPTION

The various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

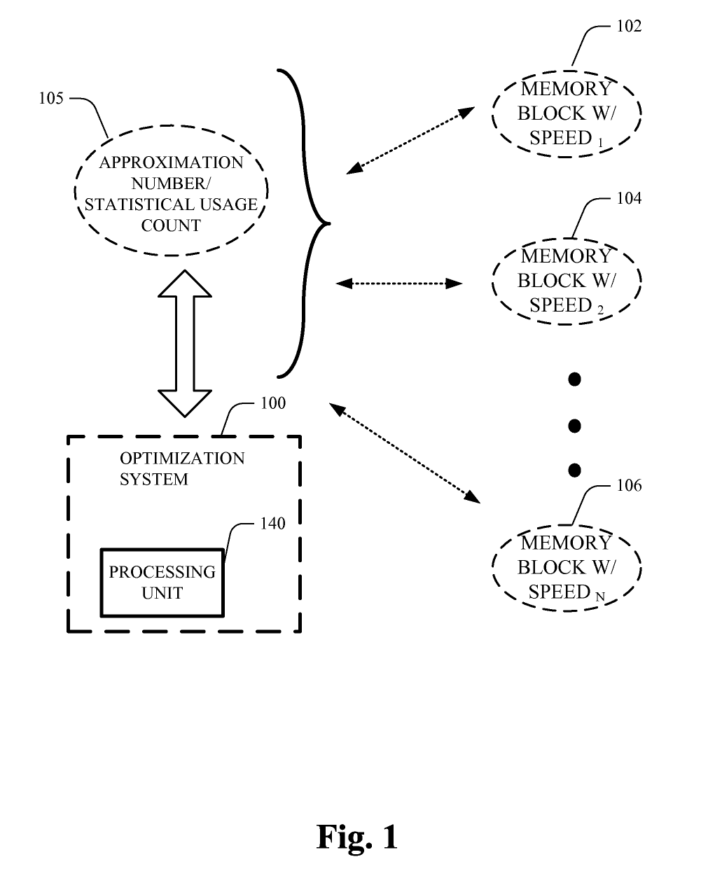

FIG. 1 illustrates a block diagram of an optimization system 100 that employs an approximation of the count to keep track of how often a chunk or piece of memory 102, 104, 106 (where N is an integer) is actually employed by the operating system (OS). The memory blocks 102, 104, 106 can form a hierarchical arrangement, wherein such hierarchical arrangement of storage can take advantage of memory locality in computer programs, for example. Each memory block 102, 104, 106 and/or level of the hierarchy can include the properties of higher speed, smaller size, and lower latency than other or lower levels. The optimization system 100 mitigates circumstances wherein the processing unit 140 (e.g., a central processing unit, a graphical processing unit) spends much of its time idling, waiting for memory I/O to complete, wherein such processing unit 140 operates so fast that for most program workloads, the locality of reference of memory accesses and the efficiency of the caching and memory transfer between different levels of the hierarchy are the practical limitation on processing speed.

Moreover, the memory blocks 102, 104, 106 can include: fastest possible access (usually 1 CPU cycle) with only hundreds of bytes in size; Level 1 (L1) cache that is often accessed in just a few cycles with usually tens of kilobytes; Level 2 (L2) cache that is higher latency than L1 by 2× to 10× with often 512 KiB or more ; Level 3 (L3) cache that is higher latency than L2 with often several MiB; Main memory (DRAM) that can take hundreds of cycles, but can be multiple gigabytes, and the like.

For example, processor registers can be positioned at the top of the memory hierarchy, and provide the fastest way for a processing unit 140 to access data. The processor register can be represented by a relatively small amount of storage available on the processing unit 140 whose contents can be accessed more quickly than storage available elsewhere. In general, a compiler can determine what data moves to which register.

Registers of the processing unit 140 can include group of registers that are directly encoded as part of an instruction, as defined by the instruction set. Such can be referred to as “architectural registers”. For instance, the x86 instruction set defines a set of eight 32-bit registers, but a CPU that implements the x86 instruction set will contain many more registers than just these eight. In particular, the operations can be based on the principle of moving data from main memory into registers, operating on them, then moving the result back into main memory (e.g., load-store architecture.) Such provides for a locality of reference, wherein the same values can often be accessed repeatedly; and holding these frequently used values in registers improves program execution performance. Accordingly, rather than keeping track of complete usage count—which can be expensive—for the memory pieces 102, 104, 106, the optimization system 100 of the subject innovation facilitates a compact manner of identifying approximately how often the memory chunk is being used, to promote efficient operation of the system as a whole.

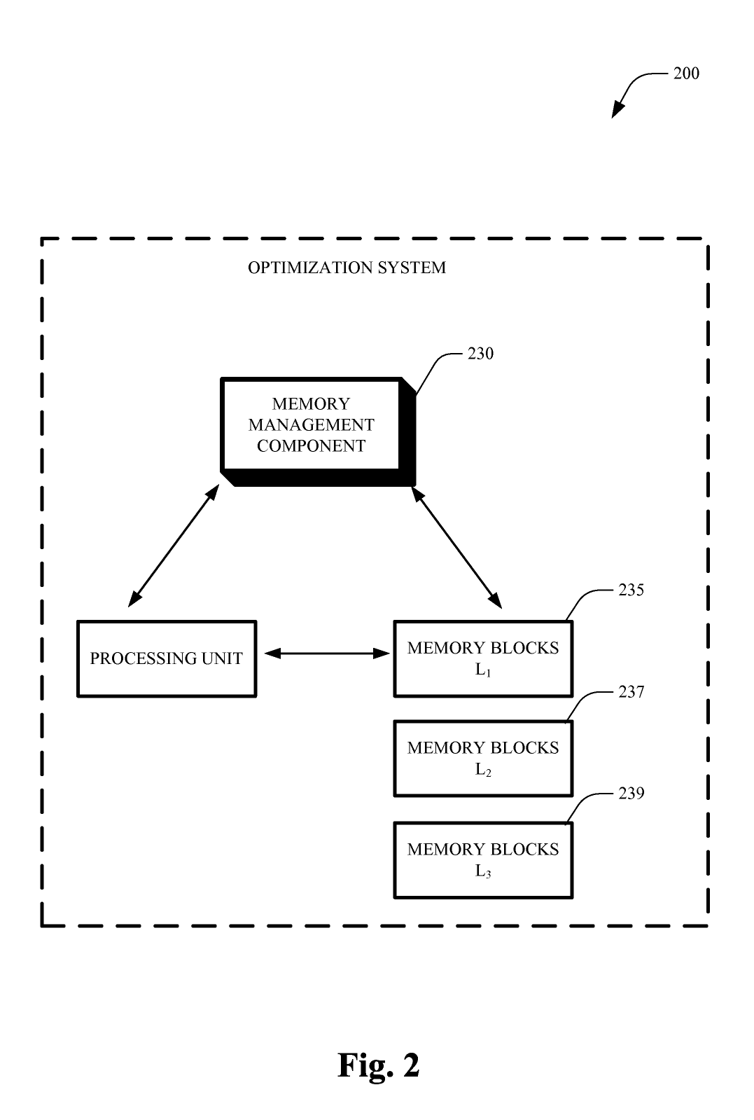

FIG. 2 illustrates a further block diagram of an optimization system 200 that includes a memory management component 230 in accordance with an aspect of the subject innovation. The memory management component 230 tracks a statistical usage count of memory locations, by a comparison thereof with a threshold value. As illustrated in FIG. 2, data storage is provided in a layered and multiple locations, wherein some locations supply faster access to data than other locations. Based on data usage during memory access and/or access to data locations, the memory management component 230 facilitates a compact manner of identifying approximately how often the memory chunk(s) 235, 237 and 239 are being used, to promote efficient operation of the system as a whole. Each memory location associated with the block 235, 237, 239 can be changed based on the corresponding memory access (e.g., data that is employed over and over can be placed in a relatively fast location, and data that is not substantially used can be placed in a location that is deemed relatively slow location.

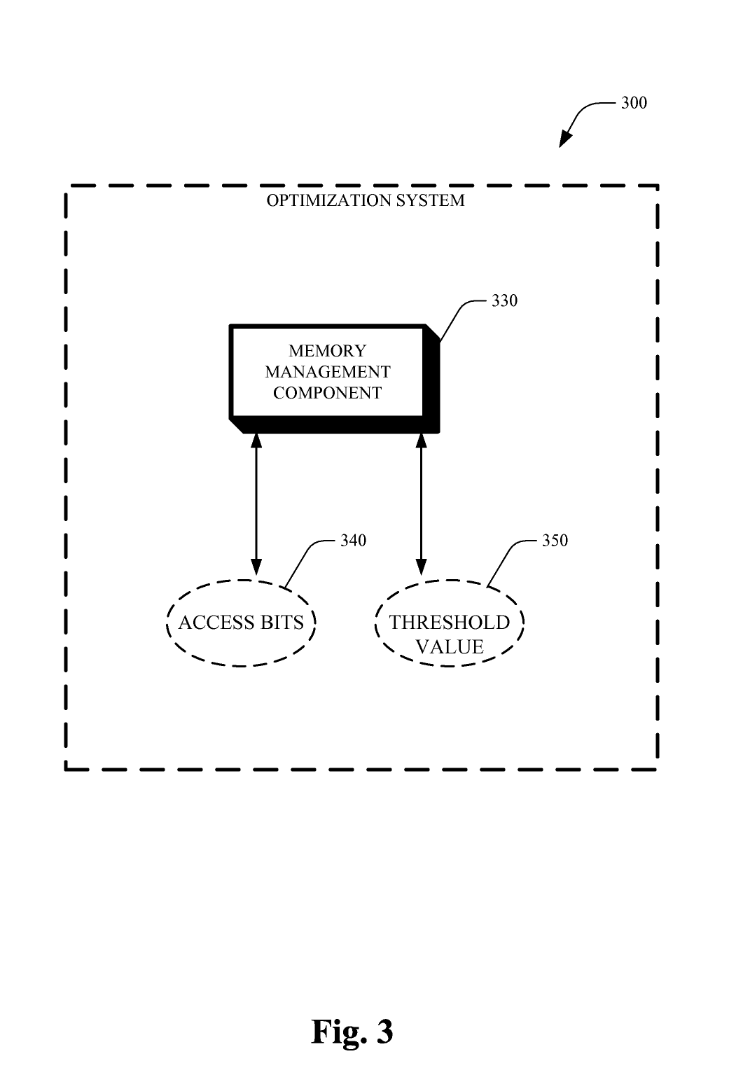

FIG. 3 illustrates the optimization system 300 that exploits a predetermined number of bits (e.g., 1 bit or 2 bits as access bits 340) to track a page (e.g., a 4K page), wherein whenever a processing unit accesses the memory a random number can be generated that can be compared against a threshold value 350. If such random number exceeds the threshold value the access bit can be turned on for the memory. Such access bit can remain on, until set to zero again (e.g., by the memory management component 330), to obtain additional data. The threshold value 350 can be adaptively adjusted depending on number of times a memory location is accessed. Such threshold value 350 can be supplied by the memory management component 330, which also reads the access bits 340. As such, whenever the processing unit accesses the memory chunks, a statistical test can be performed, which can change status of access bits (e.g., from off to on). The access bits 340 (e.g., access threshold registers) can be located within the processing unit, and based on their “on” status can provide feedback regarding allocation of memory and placement. A plurality of algorithms can be employed to track accesses to memory chunks. It is to be appreciated that such access bits have a very low probability of being set accidentally to “on” status—without substantial access as set by the threshold value 350.

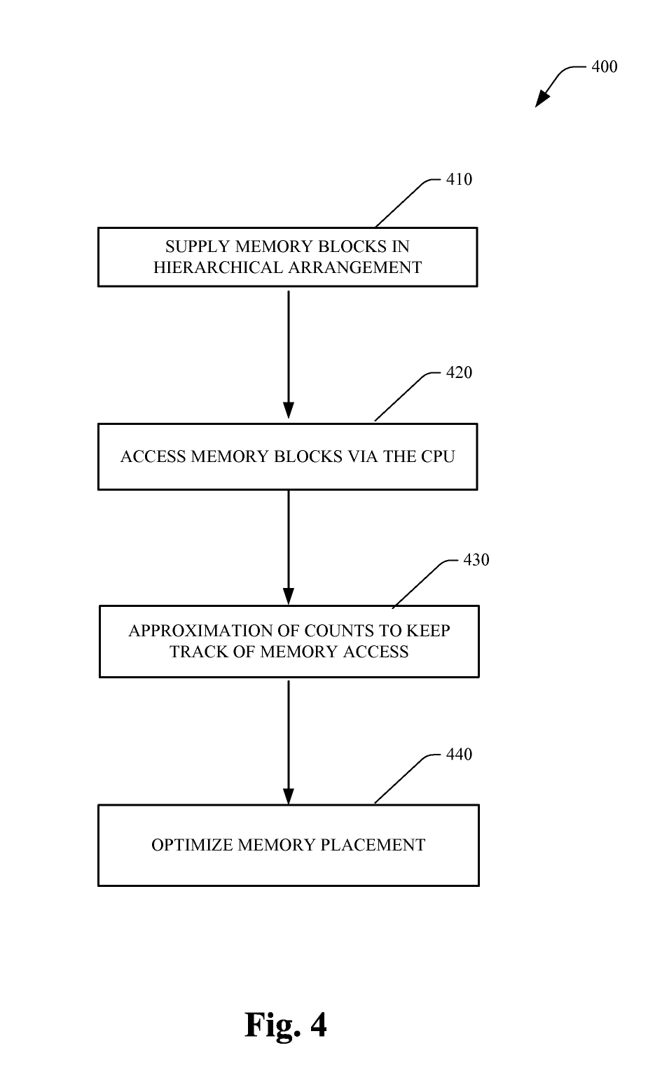

FIG. 4 illustrates a methodology 400 of optimizing memory placement in a hierarchical environment in accordance with an aspect of the subject innovation. While the exemplary method is illustrated and described herein as a series of blocks representative of various events and/or acts, the subject innovation is not limited by the illustrated ordering of such blocks. For instance, some acts or events may occur in different orders and/or concurrently with other acts or events, apart from the ordering illustrated herein, in accordance with the innovation. In addition, not all illustrated blocks, events or acts, may be required to implement a methodology in accordance with the subject innovation. Moreover, it will be appreciated that the exemplary method and other methods according to the innovation may be implemented in association with the method illustrated and described herein, as well as in association with other systems and apparatus not illustrated or described. Initially and at 410, memory blocks are supplied in hierarchical arrangement. Such hierarchical arrangement provides for data storage in a layered and multiple locations, wherein some locations supply faster access to data than other locations. Next, and at 420 the processing unit can access the memory blocks via the CPU. At 430, an approximation can be determined regarding memory access. Subsequently, based on such approximation during memory access and/or access to data locations, the methodology 400 facilitates a compact manner of identifying approximately how often the memory chunk is being used, to promote efficient operation of the system as a whole at 440.

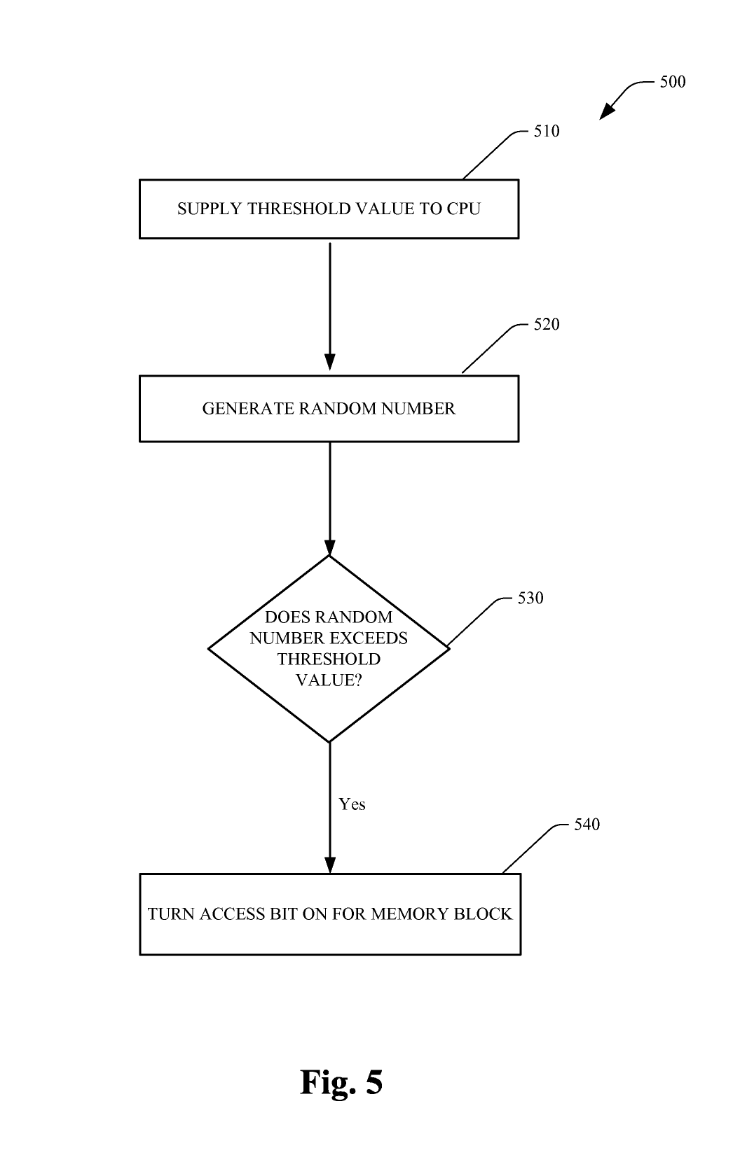

FIG. 5 illustrates a further methodology 500 of optimizing memory placement in accordance with an aspect of the subject innovation. Initially and at 510, a threshold value can be supplied to the CPU (e.g., the memory management component supplies threshold information for a memory chunk.) Each time the processing unit accesses such memory chunk a random number can be generated at 520. Such random number can then be compared with a threshold value at 530, wherein if such random number exceeds the threshold value a bit for the memory chunk can be turned on for the memory at 540.

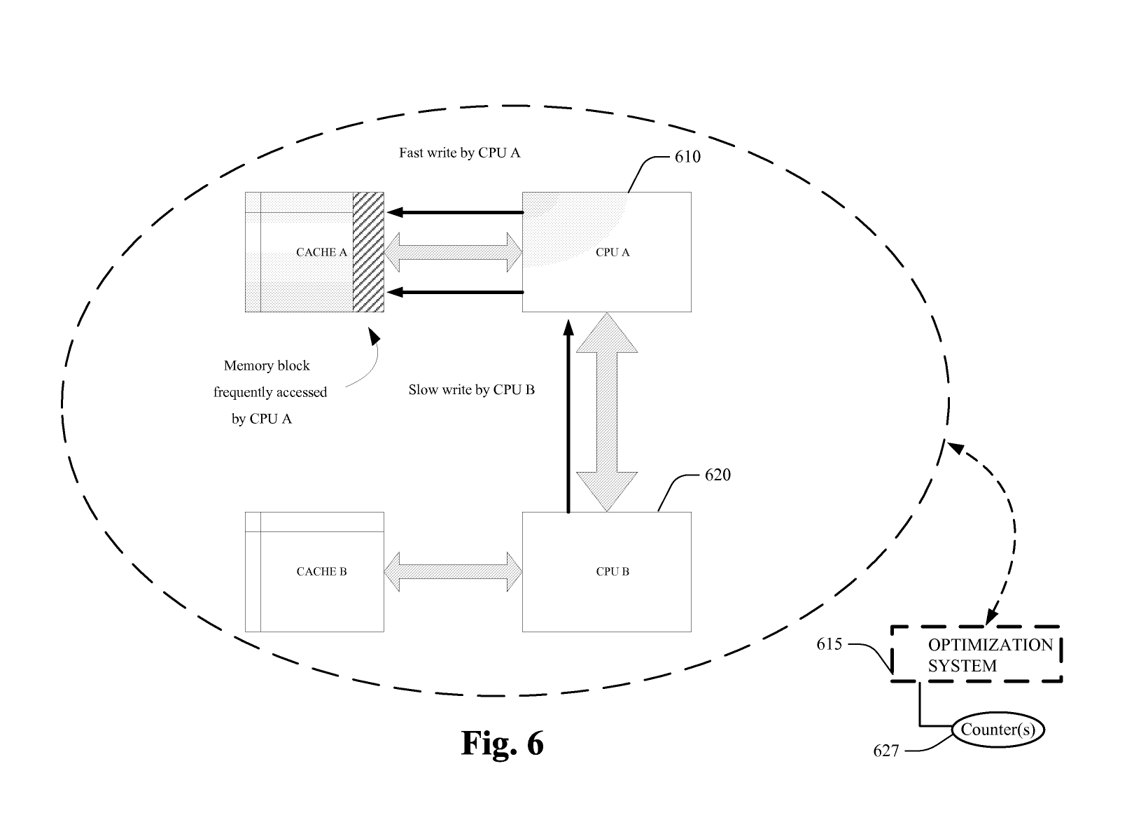

For example, and as illustrated in FIG. 6 two processors A and B can each have their own dedicated chunk of fast memory 610, 620. For this example, it is assumed that moving a block can be substantially more expensive then performance of a single access operation (e.g., a write) operation to the other processor's fast memory. If a single block is typically accessed by processor A and rarely accessed by B, then the optimization system 610 of the subject innovation moves such block, so that it reside in A's fast memory and B can be directed to use a slow access operation. Moreover, if B writes frequently then such block can then be removed to reside in B's fast memory.

As explained earlier, rather than keeping an exact count of memory accesses to a block in order to determine—the optimization system 615 employs an approximation of the count to keep track of how often a chunk or piece of memory is actually employed by the operating system (OS). For example, when the central processing unit (CPU) A 610 accesses the memory, a bit associated therewith is then turned on. Every time that the CPU accesses the memory, an increment of the counter occurs. Likewise, the CPU B 620 can access the memory and a bit associated therewith is also turned on. Upon accessing the memory by CPU A 610 or B 620, the optimization system 615 further employs a heuristic counter(s) 627 to track memory accesses via increments and/or resets thereto, wherein such counter 627 is read and subsequently cleared from the optimization system 615 of the subject innovation. Accordingly, activities of different processing units for access to memory locations can be monitored and compared to optimize memory placement. For example, in one aspect the counter(s) 627 can be a Generalized Flexible Randomized Counter (GFRC). Such counter can be read and cleared from the memory optimizer that can be implemented in hardware or software, such as the access bits described above. For example, generation of 127 random bits can be denoted as R[127:0]. In case of a generalized 128-bit generalized GFRC[127:0], at each memory operation, 128 random bits are generated=R[127:0]. If all 128 bits are set in R, then GFRC[127] is set, and if R[126:0] are all set, then GFRC[126] can be set. In general, the probability that GFRC[i] is set after one operation is exactly 1 in 2⁽ⁱ⁺¹⁾ (where i is an integer.)

When the data is read back, the highest set bit indicates an estimate of the number of times that the counter is “incremented”. To make such counter flexible, it is noted that each bit of the GFRC can be computed independently and thus only a subset of bits needs be stored. Thus, an FRC{0,10,20,30,40,50,60} can return 7 bits, which can supply a statistical estimate of whether there was 1 or more accesses, 2¹⁰ or more accesses, 2²⁰ or more accesses, etc. For even greater storage efficiency, a k-bit FRC (where k is an integer) could be stored by employing (1+log₂ k)-bit counter. To reduce the number of random bits, serially generating random bits and stopping at the first zero (or until the limit is reached) will typically only require a few random bits. On average, only two random bits can be generated regardless of what the counter range. For example, such can be represented as follows:

PseudoCode:

Reset Counter( ):
GFRC[127:0] ←0;
End;
IncrementCounter( ):
L ← 0
While (Random( ) == 1 &&L < 127)
L++;
GFRC[L] ← 1
End;

Random is assumed to return 1 with probability of ½. To store the GFRC as a counter, we have the following:

IncrementCounter( ): (
L ← 0
While (Random( ) == 1 &&L < 127)
L++;
GFRC ← max(GFRC, L);
End;

Dynamic FRC:

The values used for the FRC levels can be set dynamically. For example, FRC(0, a, b, c) where {a, b, c} are values that are set by the optimization system 615. For example, considering a system that has 64MB of fast memory and 1 TB of slow memory, it can be assumed that the FRC{0, 10} system is in place. While all blocks with no references can be put into slow memory, if there is more than 64 MB of blocks where bits are set to true, it can become unclear what should be put where. With a dynamic system, the FRC{0, 10} can be adjusted to FRC{0, 20} so that approximately 64 MB of memory can be identified as being HIGH-Frequency, and hence worthy of being put into the fast memory. It is to be appreciated that if substantially little memory is marked as high frequency, then the opposite problem occurs, and adjusting the FRC range as described earlier can facilitate identifying the proper placement of blocks.

High Resolution FRC

In the above examples, it can be assumed that that the FRC and GFRC employ powers of two as the threshold levels. This minimizes the hardware costs and facilitates exposition. Such is a mere assumption and for higher control and granularity of counters, the following approach can be employed:

GPU Register

| | |
|---|---|
| AccessThreshold0 | 32 bits |
| AccessThreshold1 | 32 bits |
| AccessThreshold2 | 32 bits |
| AccessThreshold3 | 32 bits |

Memory Access

PageAccessInformation = ReadPageAccessInformationFromAccessBits( )
RandomValue = Generate32bitRandomValue( )
PageAccessInformation[0] |= (RandomValue < AccessThreshold0)
PageAccessInformation[1] |= (RandomValue < AccessThreshold1)
PageAccessInformation[2] |= (RandomValue < AccessThreshold2)
PageAccessInformation[3] |= (RandomValue <
AccessThreshold3)
WritePageAccessInformationBackToAccessBits( )

In accordance with the example above, instead of a 60 bit counter, an FRC can be implemented in only 3 bits and still (probabilistically) distinguish between thousands of accesses in accordance with an aspect of the subject innovation (versus sextillions of accesses). Moreover, range independent of storage, for only 2 bits, FRC{0, 10, 100} can be computed. Accordingly, such information facilitates memory block placement via hardware or software based placement schemes. In particular, this information can lead to choices than superior to those of an LRU approach at a much lower practical cost. In addition, dynamic adjustment allows for changing access patterns and efficient, accurate placement of the highest frequency blocks into the most efficient memory.

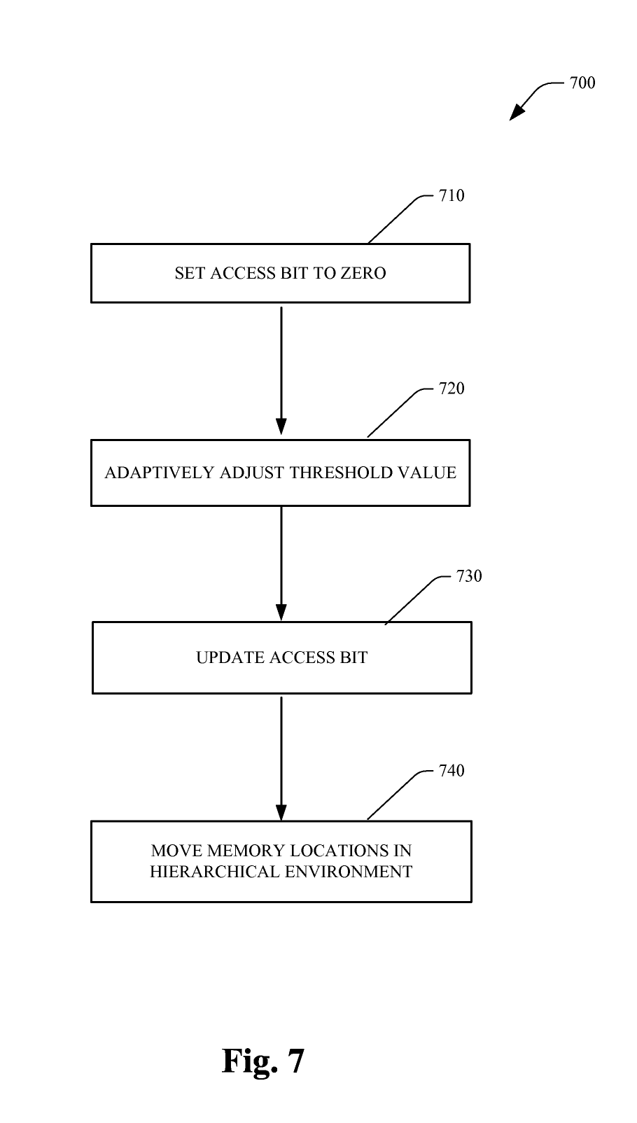

FIG. 7 illustrates a related methodology 700 of moving memory locations in accordance with an aspect of the subject innovation. The access bits associated with a memory block can be set to zero (e.g., by the memory management component), to obtain additional data. Subsequently and at 720, the threshold value can be adaptively adjusted depending on number of times a memory location is accessed. Based on such threshold value, access bits can be updated at 730, wherein the memory management can read back the access bits. Next, from such reads of the access bit memory, locations can be moved in the hierarchal environment (e.g., data in most accessed memory locations are moved to locations with can be accessed the fastest). Accordingly, the CPU can track the memory accesses using the threshold information and updates to the access bits.

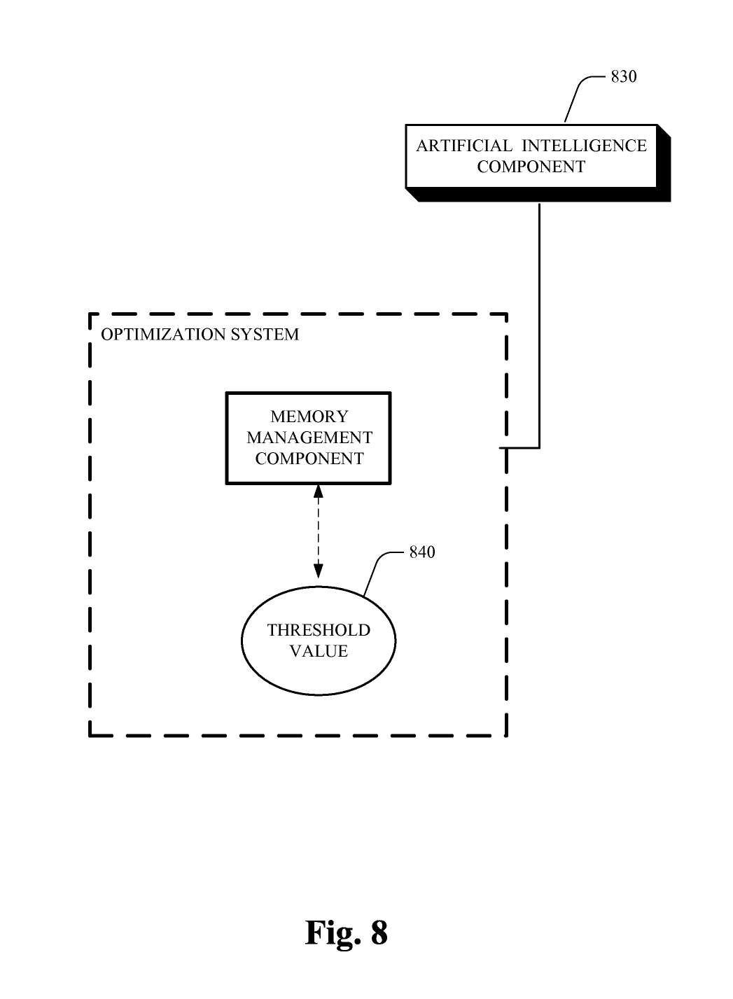

FIG. 8 illustrates an artificial intelligence (AI) component 830 that can be employed to facilitate inferring and/or determining when, where, how to change the threshold value 840 in accordance with an aspect of the subject innovation. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

The AI component 830 can employ any of a variety of suitable AI-based schemes as described supra in connection with facilitating various aspects of the herein described invention. For example, a process for learning explicitly or implicitly how to adaptively adjust the threshold value 840 can be facilitated via an automatic classification system and process. Classification can employ a probabilistic and/or statistical-based analysis (e.g., factoring into the analysis utilities and costs) to prognose or infer an action that a user desires to be automatically performed. For example, a support vector machine (SVM) classifier can be employed. Other classification approaches include Bayesian networks, decision trees, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information) so that the classifier is used to automatically determine according to a predetermined criteria which answer to return to a question. For example, with respect to SVM's that are well understood, SVM's are configured via a learning or training phase within a classifier constructor and feature selection module. A classifier is a function that maps an input attribute vector, x=(x1, x2, x3, x4, xn), to a confidence that the input belongs to a class—that is, f(x)=confidence(class).

The word “exemplary” is used herein to mean serving as an example, instance or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner. It is to be appreciated that a myriad of additional or alternate examples could have been presented, but have been omitted for purposes of brevity.

Furthermore, all or portions of the subject innovation can be implemented as a system, method, apparatus, or article of manufacture using standard programming and/or engineering techniques to produce software, firmware, hardware or any combination thereof to control a computer to implement the disclosed innovation. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

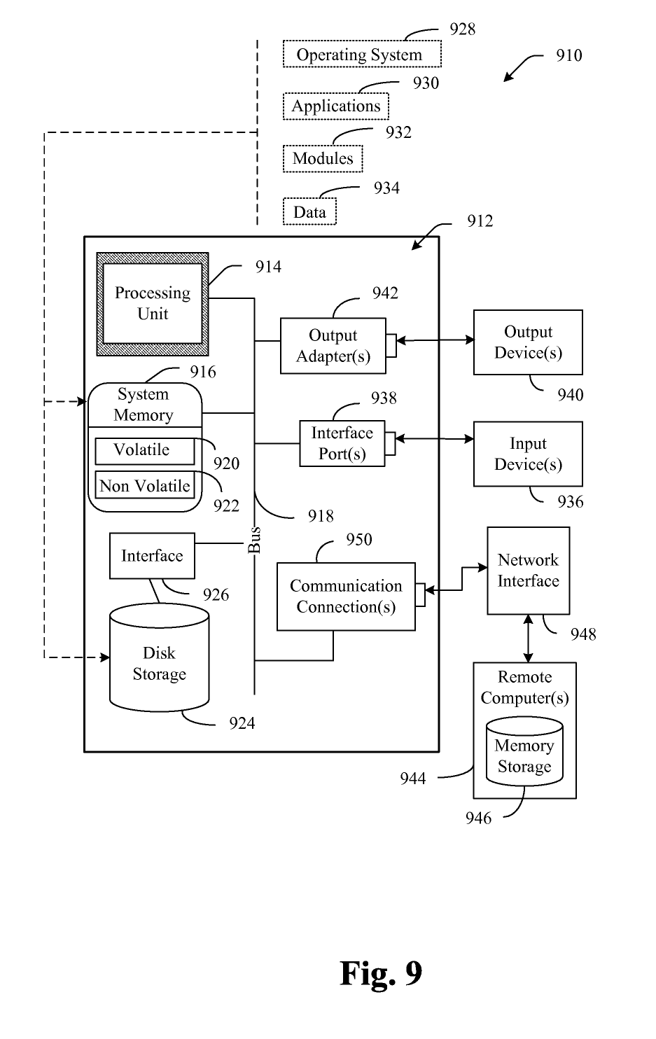

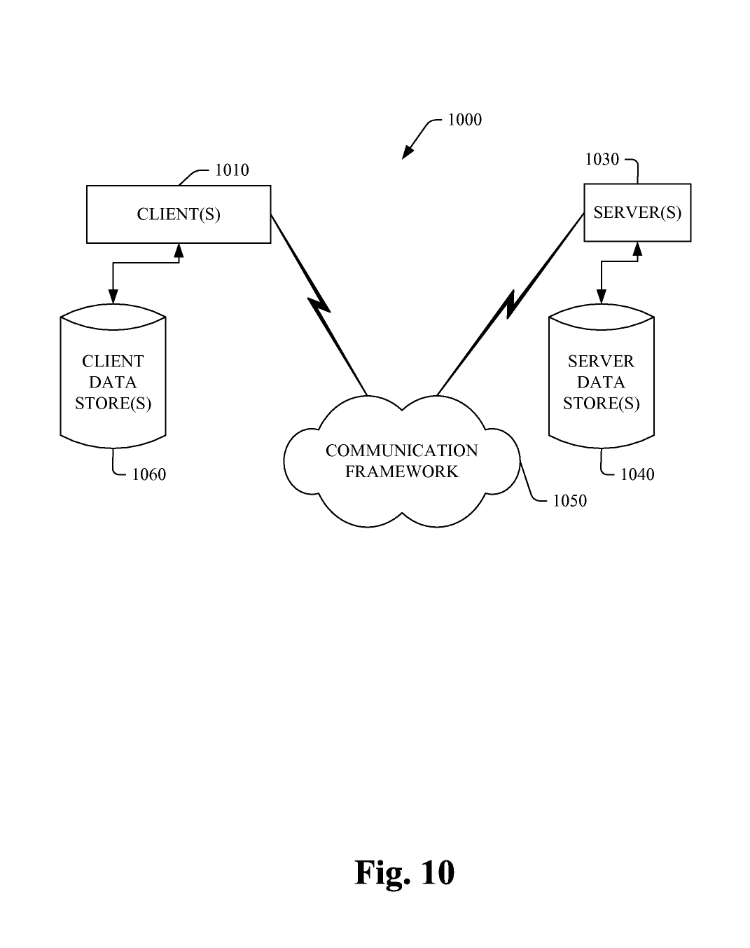

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the innovation also may be implemented in combination with other program modules. Generally, program modules include routines, programs, components, data structures, and the like, which perform particular tasks and/or implement particular abstract data types. Moreover, those skilled in the art will appreciate that the innovative methods can be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the innovation can be practiced on stand-alone computers. In a distributed computing environment, program modules may be located in both local and remote memory storage devices.

With reference to FIG. 9, an exemplary environment 910 for implementing various aspects of the subject innovation is described that includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/non-removable, volatile/non-volatile computer storage media. FIG. 9 illustrates a disk storage 924, wherein such disk storage 924 includes, but is not limited to, devices like a magnetic disk drive, floppy disk drive, tape drive, Jaz drive, Zip drive, LS-60 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that various components described herein can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940 that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

FIG. 10 is a schematic block diagram of a sample-computing environment 1000 that can be employed for implementing the optimization system of the subject innovation. The system 1000 includes one or more client(s) 1010. The client(s) 1010 can be hardware and/or software (e.g., threads, processes, computing devices). The system 1000 also includes one or more server(s) 1030. The server(s) 1030 can also be hardware and/or software (e.g., threads, processes, computing devices). The servers 1030 can house threads to perform transformations by employing the components described herein, for example. One possible communication between a client 1010 and a server 1030 may be in the form of a data packet adapted to be transmitted between two or more computer processes. The system 1000 includes a communication framework 1050 that can be employed to facilitate communications between the client(s) 1010 and the server(s) 1030. The client(s) 1010 are operatively connected to one or more client data store(s) 1060 that can be employed to store information local to the client(s) 1010. Similarly, the server(s) 1030 are operatively connected to one or more server data store(s) 1040 that can be employed to store information local to the servers 1030.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims.

Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer implemented system comprising the following computer executable components:
a hierarchical or distributed memory environment that includes a plurality of memory blocks with different speeds; and
an optimization system that employs an approximation of counts for memory block access, to re-arrange memory locations.

2. The computer implemented system of claim 1 further comprising a memory management component that tracks the approximation of counts.

3. The computer implemented system of claim 1 further comprising access bits that facilitate determination for the approximation of counts.

4. The computer implemented system of claim 3, the optimization system associated with a statistical usage count that is compared to a threshold value.

5. The computer implemented system of claim 4, the threshold value adaptively adjustable based on memory access.

6. The computer implemented system of claim 1 further comprising heuristic counter(s) to track memory accesses via increments or resets.

7. The computer implemented system of claim 6, the heuristic counter is a flexible randomized counter (FRC).

8. The computer implemented system of claim 4 further comprising an artificial intelligence component that facilitates a set of the threshold value.

9. The computer implemented system of claim 7, the FRC is dynamic.

10. A computer implemented method comprising the following computer executable acts:
tracking a memory access in a hierarchical memory arrangement via a statistical usage count; and
re-arranging locations of the hierarchical memory based on the statistical usage count.

11. The computer implemented method of claim 10 further comprising generating a random number upon accessing a memory block in the hierarchical memory arrangement.

12. The computer implemented method of claim 11 further comprising comparing the random number with a predetermined threshold.

13. The computer implemented method of claim 11 further comprising changing a status of an access bit to on, upon the random number exceeding the predetermined threshold.

14. The computer implemented method of claim 11 further comprising setting an access bit to zero.

15. The computer implemented method of claim 14 further comprising adaptively adjusting the threshold value.

16. The computer implemented method of claim 14 further comprising updating the access bit.

17. The computer implemented method of claim 16 further comprising monitoring activities of different processing units associated with the hierarchical memory arrangement.

18. The computer implemented method of claim 17 further comprising incrementing counters upon memory access.

19. The computer implemented method of claim 18 further comprising inferring a value to be set for the predetermined threshold based on heuristics.

20. A computer implemented method comprising the following computer executable acts:
means for tracking access to memory locations via a statistical usage count; and
means for optimizing memory operations based on the statistical usage location.
